(19) United States
(12) Patent Application Publication
(10) Pub. No.: US 2008/0097927 A1
(43) Pub. Date: Apr. 24, 2008

(54) Method and System for Allowing a User to Make A Plurality of Offers to a Plurality of Advertisers

(75) Inventor: Joseph Renzi, New South Wales (AU)

Correspondence Address: BROOKS KUSHMAN P.C., 1000 TOWN CENTER, TWENTY-SECOND FLOOR, SOUTHFIELD, MI, 48075, US

(73) Assignee: SWAPACE PTY LTD, Bexley, NSW (AU)

(21) Appl. No.: 11/572,651

(22) PCT Filed: Jul. 15, 2005
(86) PCT No.: PCT/AU05/01049

§ 371 Date: Jan. 25, 2007

(30) Foreign Application Priority Data
Jul. 30, 2004 (AU) 2004904289

(51) Int. Cl. G06Q 10/00; G06Q 20/00; G06Q 30/00

(52) U.S. Cl. 705/80

(57) ABSTRACT

An electronic trading system (100) for allowing a user (101) to make a plurality of offers (102) to a plurality of advertisers (103, 104), each offer being for an advertised item (105, 106). The system (100) includes a memory device for storing information related to the offers (102). A processor, in the form of an Offer Management System (OMS) (107), is disposed in communication with the memory device, the OMS being configured to: receive from the user the offers (108, 109) for each advertisers' item (105, 106); transmit data (110, 111) indicative of the offers (108, 109) to the related advertisers (103, 104); receive from one of the advertisers (103) data indicative of the acceptance of the offer (112); and retract the remaining offer (109) such that only one of the offers (108, 109) is accepted.

### FIELD OF THE INVENTION

The present invention relates to a method and system for allowing a user to make a plurality of offers to a plurality of advertisers.

The invention has been developed primarily as an Offer Management System (OMS) and will be described hereinafter with reference to this application. However, it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Electronic trading systems and in particular Internet based auction systems are becoming increasingly popular for both buyers and sellers. The Internet, or other online environments, offer many advantageous for both buyers and sellers over traditional auctions and retail shopping. Buyers are able to quickly search through the goods of many sellers without having to physically travel to different stores. Sellers on the other hand have access to a large number of buyers from around the world.

Typically on an Internet auction site, a buyer will search for an item that is offered for sale by a number of different sellers. In some cases, the buyer will be able to purchase the item immediately for a given price, although this typically is higher than would be so if the item were ultimately purchased by auction. Buyers therefore often place a plurality of bids with a plurality of sellers to increase their chance of purchasing a desired item through one of the auction processes. However having placed a number of bids, the buyer risks agreeing to purchase more than one of the item.

A further disadvantage of current OMS' s is that buyers need to actively seek advertisements for items they wish to purchase. This means that sellers are unable to actively promote their items to individual or specific buyers and must wait for a buyer to look at their advertisement.

### DISCLOSURE OF THE INVENTION

It is an object of the present invention to overcome or ameliorate at least one of the disadvantages of the prior art, or to provide a useful alternative.

It is an object of the invention in its preferred form to provide a method and system for allowing a user to make a plurality of offers to a plurality of advertisers.

According to a first aspect of the invention there is provided a method for allowing a user to make a plurality of offers to a plurality of advertisers, each offer being for an advertised item, the method including the steps of:
(a) receiving one or more offer signals that are indicative of the plurality of offers;
(b) being responsive to the offer signals for sending an advertiser signal to at least two of the advertisers, wherein the advertiser signal is indicative of the offers;
(c) being responsive to an acceptance from one of the at least two advertisers for retracting the remaining offer or offers.

Preferably, the offer signals are received by an Offer Management System (OMS). More preferably, the OMS sends the advertiser signals and receives the acceptance signals. Even more preferably, the OMS retracts the remaining offer or offers.

Preferably, each advertised item is related to an advertisement. More preferably, each advertised item is related to a respective advertisement. In some embodiments the advertisement is for an item the advertiser wishes to sell and the offer is an offer to purchase the item from the advertiser. In other embodiments, the advertisement is for an item the advertiser wishes to buy and the offer is an offer to sell the item to the advertiser.

In some embodiments, the method includes the step of:

(d) the OMS sending a confirmation signal to the user, wherein the confirmation signal is indicative of the acceptance signal.

Preferably, the method includes the step of:

(e) receiving by the OMS a notification of payment between the user and the advertiser.

Preferably, the payment from the user to the advertiser is by exchange of legal tender. In some embodiments, the payment is by exchange of goods and/or services. In other embodiments, the items include goods and/or services.

Preferably also, the OMS includes a list created by the user for listing predetermined items which the user wishes to purchase or sell. Preferably also, the list is publicly available for viewing by other users. In some embodiments, the method includes the step of creating an advertisement for one or more of the items on the list. Preferably, the advertisement is in the form of an online auction conducted with the OMS. In other embodiments the advertisement is in the form of an instant purchase conducted with the OMS. In some embodiments, the advertisement is in the form of a trade conducted with the OMS. Preferably also, each predetermined item on the list is selectively available for viewing by other users.

According to a second aspect of the invention there is provided a method for allowing a user to make a plurality of offers to a plurality of advertisers, each offer being for an advertised item, the method including the steps of:
(a) receiving one or more offer signals that are indicative of the plurality of offers;
(b) being responsive to the offer signals for sending an advertiser signal to at least two of the advertisers, wherein the advertiser signal is indicative of the offers;
(c) receiving one or more counter-offers from at least one of the advertisers.

In some embodiments the method includes the step of:
(d) sending a signal indicative of the at least one counter-offer to the user.

Preferably, the method includes the step of:

(e) being responsive to an acceptance signal from the user for retracting the remaining counter-offer or counter-offers.

Preferably, the offer signals are received by an Offer Management System (OMS). More preferably, the OMS sends the advertiser signals. More preferably, the OMS receives the one or more counter-offers. More preferably, the OMS sends the signal indicative of the at least one counter-offer to the user. Even more preferably, the OMS retracts the remaining counter-offer or counter-offers.

According to a third aspect of the invention there is provided an offer management system adapted to accept a plurality of offers from a user for a plurality of items advertised by a plurality of advertisers and sending the offers to the related advertisers for acceptance, wherein if one of the offers is accepted then the offer management system retracts the remaining offers.

According to forth aspect of the present invention there is provided a computer device for allowing a user to make a plurality of offers to a plurality of advertisers, each offer being for an advertised item, the computer device including:
a memory device for storing information related to the offers;
a processor disposed in communication with the memory device, the processor configured to:
receive from the user the offers for each advertisers' item;
transmit data indicative of the offers to the related advertisers;
receive from one of the advertisers data indicative of the acceptance of the offer; and
retract the remaining offers such that only one of the offers is accepted.

Preferably, the computer device is part of an Offer Management System (OMS). Preferably, each advertised item is related to an advertisement. More preferably, each advertised item is related to a respective advertisement. In some embodiments the advertisement is for an item the advertiser wishes to sell and the offer is an offer to purchase the item from the advertiser. In other embodiments, the advertisement is for an item the advertiser wishes to buy and the offer is an offer to sell the item to the advertiser.

Preferably also, the processor is further configured to send a confirmation signal to the user, wherein the confirmation signal is indicative of the acceptance of the offer.

In some embodiments, the processor is further configured to receive a notification signal from the user, wherein the notification signal is indicative of payment between the user and the advertiser.

Preferably, the payment from the user to the advertiser is by exchange of legal tender. In some embodiments, the payment is by exchange of goods and/or services. In other embodiments, the items include goods and/or services.

Preferably also, the processor is further configured to receive from the user a list created by the user for listing predetermined items which the user wishes to purchase or sell. Preferably also, the list is publicly available for viewing by other users. In some embodiments, the processor is further configured to create an advertisement for one or more of the items on the list. Preferably, the advertisement is in the form of an online auction conducted with the OMS. In other embodiments the advertisement is in the form of an instant purchase conducted with the OMS. In some embodiments, the advertisement is in the form of a trade conducted with the OMS. Preferably also, each predetermined item on the list is selectively available for viewing by other users.

According to another aspect of the invention there is provided an electronic trading system for allowing a user to make a plurality of offers to a plurality of advertisers, each offer being for an advertised item, the system including:

a memory device for storing information related to the offers;

a processor disposed in communication with the memory device, the processor configured to:

receive from the user the offers for each advertisers' item;

transmit data indicative of the offers to the related advertisers;

receive from one of the advertisers data indicative of the acceptance of the offer; and

retract the remaining offers such that only one of the offers is accepted.

### BRIEF DESCRIPTION OF THE DRAWINGS

Preferred embodiments of the invention will now be described, by way of example only, with reference to the accompanying drawings in which:

FIG. 1 is a schematic diagram of an OMS that is operated in accordance with an embodiment of the invention;

FIG. 2 is a schematic diagram of a wish-list for a user of the OMS of FIG. 1;

FIG. 3 is a schematic diagram of a server for implementing an embodiment of the invention;

FIG. 4 is a flow-chart illustrating one sequence of operations of the OMS of FIG. 1 that leads to a transaction;

FIG. 5 is a flow-chart that illustrated one sequence of operations of the OMS of FIG. 1 following the transaction of FIG. 4;

FIG. 6 is a schematic diagram of system hardware used to implement the flow-chart of FIG. 4; and

FIG. 7 is a database schema diagram for implementing the operations set out in FIGS. 4 and 5.

### PREFERRED EMBODIMENT OF THE INVENTION

The preferred embodiment of the present invention provides a method and system for allowing a user to make a plurality of offers to a plurality of advertisers. The offers are in response to advertisements for items listed on an Offer Management System (OMS) wherein if one offer is accepted, then the remaining offers are automatically retracted. In this way users and advertisers are prevented from entering multiple transactions when only a single transaction is desired.

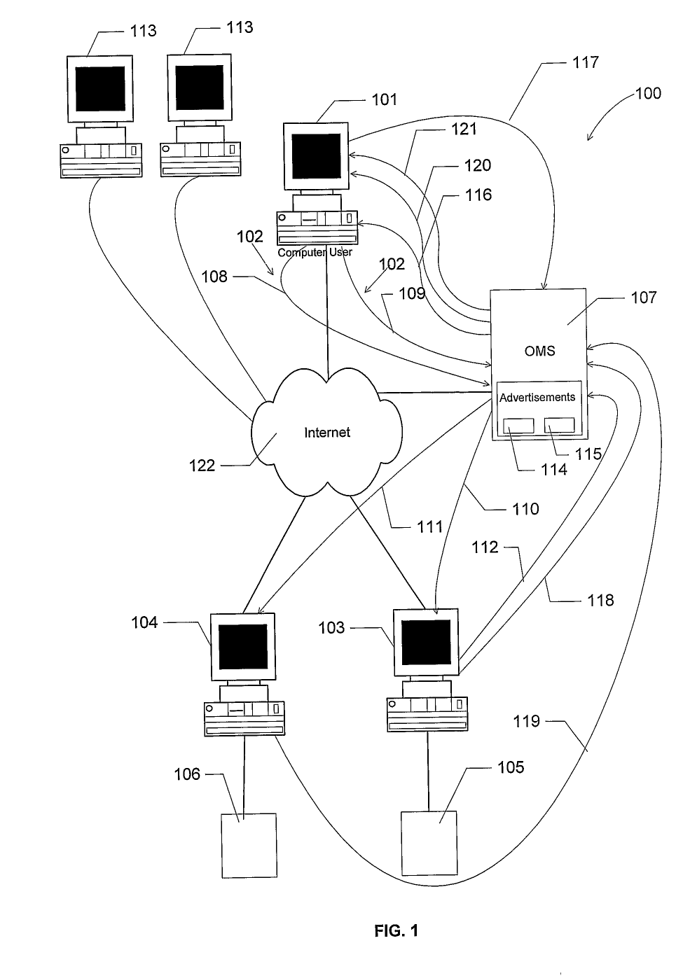

Referring to FIG. 1 there is shown an electronic trading system 100 for allowing a user 101 to make a plurality of offers 102 to a plurality of advertisers 103 and 104, each offer being for an advertised item 105 and 106 respectively. An OMS 107 receives offer signals 108 and 109 that are indicative of the offers 102 for items 105 and 106 respectively. The OMS 107 is responsive to the offer signals 108 and 109 for sending advertiser signals 110 and 111 that are indicative of the offers 102, to the respective advertisers 103 and 104.

In this embodiment, the offers 102 include details such as the offer price, that is the amount of goods and/or services and/or legal tender the user 101 is willing to exchange for the items 105 or 106. In other embodiments, the offers include other details such as offer validity date, auction close date, the sale or exchange price and others.

The OMS 107 is responsive to an acceptance signal 112, in this instance sent from advertiser 103 to the OMS, for retracting the remaining offer 109 such that only one of the offers, that is offer 108, is accepted by one of the advertisers 103.

The advertised items 105 and 106 are related to advertisements 114 and 115 respectively that have been placed on the OMS 107. The advertisements are available to be viewed by other users, such as users 113, and of course user 101. In this embodiment the advertisements 114 and 115 are in the form of a traditional advertisement for sale and the advertisements specify a description of the goods and/or services and a sale price. Typically, the sale will include a date up until when received offers will be considered by the advertiser, but in some embodiments no such date is used. In some embodiments, the advertisements are for an auction, a reverse auction or for trade and bartering. It will however be understood that there are any number of different sale types that are available for linking to the advertisements.

It will be understood that the advertised items 105 and 106 are items that advertisers 103 and 104 wish to purchase or sell. That is the advertisements are to sell a physical product or service or a desire to buy a physical product or service. In some embodiments the advertisements are to swap a physical product or service. In other embodiments, the advertisement is to advertise a message or event. In this example the advertisers 103 and 104 are both selling, say sunglasses and the advertisements 114 and 115 are for sunglasses 105 and 106. However in another example, the advertisers 103 and 104 both wish to purchase sunglasses and the advertisements 114 and 115 are placed to advertise that wish. In that instance, the items 105 and 106 are the desire to purchase sunglasses and the user 101 when making offers 102 is offering to sell sunglasses to advertisers 103 and 104. It will be understood that in some embodiments there will be many thousands of users and advertisers and that there will be many thousands of simultaneous advertisements to buy and sell items. There will also be many thousands of offers between the users and advertisers to buy and sell those items. That is, there are both advertisements to buy and sell items as well as both offers to buy and sell items on the OMS at any one time.

When the OMS 107 receives the acceptance signal 112, a confirmation of acceptance signal 116 is sent to user 101. At this stage, the OMS 107 retracts the remaining offer 109 so that it no longer able to be accepted by advertiser 104. Consequently the user 101 is prevented from entering into transactions with both advertisers 103 and 104. It will be understood that the acceptance signal 112 is indicative of the acceptance signal and contains relevant information such as payment details, email addresses, physical addresses and so on.

Assuming in this instance, user 101 is purchasing item 105, payment is made according to information provided by the OMS 107 or directly to the advertiser 103. Once payment is made, a notification of payment 117 is sent to the OMS 107 and the transaction is concluded. In some embodiments, notification of payment is not sent to the OMS.

In this embodiment the payment from the user 101 to the advertiser is by exchange of legal tender. In other transactions and other embodiments, the payment is by exchange of goods and/or services. In some transactions, the items include goods and/or services. In some embodiments payment is made between the user and the advertiser by using an auto payment system. In these embodiments, users have prepaid credit on the OMS and the OMS provider acts as an escrow service to ensure the successful completion of a transaction.

It will be understood the users of the OMS 107 are buyers or sellers, depending on which side of the transaction they are involved. That is, in some transactions, the user is buying an item, while in others the same user is selling an item.

It will also be understood that the term item is meant to encompass goods and/or services. In some embodiments, users and advertisers exchange goods for services, goods for money and/or services, services for goods and/or money or even services for services. In other embodiments, the items are messages. That is, the items are personal and event advertisements such as personal advertisements on an online dating website. In other embodiments, the item is an advertisement for an event such as a rock concert. In some embodiments, the item is for the sale of tickets for events such as a rock concert. In some embodiments the item is an advertisement where a user is looking to purchase tickets to an event such as a rock concert.

In the event that neither of the advertisers 103 and 104 accepts the respective offers 108 and 109, either or both of the advertisers are able to make a counter-offer to the user 101. In this example both advertisers choose not to accept the offers 103 and 104 and make respective counter-offers 118 and 119 to the user 101. Details of the counter-offers are sent to the OMS 107 that sends counter-offer signals 120 and 121 to the user 101. If the user chooses to accept one of the counter-offers, say 118, the notification of acceptance is sent to the OMS in a similar manners as described above and the other counter-offer 119 is retracted so that only one of the counter-offers is accepted. The buyer and advertiser are then able to conclude the sale in a similar fashion to that described above.

It will be appreciated that in the preceding example, while all information is via the Internet 122, the arrows denoting information flow are shown for ease of understanding.

In the preferred embodiment, the system 100 is an online trading and auction website and the functionality to retract the remaining offers, that is those that have not been accepted, is provided by the OMS 107. However, it will be appreciated that in other embodiments, the functionality of the OMS is implemented in a number of different manners. As described above, the OMS 107 receives details of offers for items from users and transmits the details of the offers to the advertisers. If an advertiser accepts one of the offers, the notification of acceptance of the offers is sent to the OMS 107 and the OMS retracts the remaining offers. The user is then notified that the offer has been accepted and notification is sent to the remaining, unsuccessful advertiser, to inform them that the offers made for their items have been retracted.

In one embodiment, the OMS allows a user to place a plurality of offers on a plurality of items and allows the user to determine, whether in the event that one of the offers is accepted, the other offers should be retracted. It will be understood that in some circumstances, the user desires more than one of the same item and therefore the remaining offers are not retracted until other predetermined conditions are met.

In some embodiments, the remaining offers are retracted only if the plurality of offers are for identical items offered for sale by different advertisers. In other embodiments, the items are different but are alternatives to one other. For example, a user desires a pair of sunglasses and has made a number of offers for a number of different models and brands of sunglasses that the user determines to be alternatives. In that case, if one of the offers made for any of the pairs of sunglasses is accepted, the remaining offers are retracted. In other embodiments, the OMS allows the buyer to determine whether the remaining offers should be retracted irrespective of the item for which the offer is made. For example, if a user desires a number of items, such as a radio, sunglasses and a TV but has a limited budget in which they cannot afford all three items, the user can request that if one of the offers that is placed is accepted, the offers on the other two items are retracted. In that example, the user is only able to afford one of the items and does not care which items is ultimately purchased.

In other embodiments, the OMS allows the user to set a budget and will not retract the remaining offers unless the budget will be exceeded. For example, if the user wishes to buy a radio, sunglasses and a TV and has a budget of $100, the offers are placed and the OMS will not retract the remaining offers unless the budget will be exceeded. In this example, if an offer of $30 is accepted for the radio, this leaves a budget of $70 remaining. Therefore unless each of the offers for the TV and the sunglasses are more than $70, the offers will not be retracted. If an offer of $40 for the sunglasses is then accepted, $70 of the budget will have been spent and the buyer will have $30 remaining. Therefore if the offer for the TV is for less than $30, then the offer for the TV will not be retracted because the budget will not be exceeded. However, if the offer for the TV is more than $30, this would mean that the budget would be exceeded. Therefore the offer is retracted to prevent the budget from exceeding the limit set by the user. In the event that the offer for the TV is less than $30 and is in fact accepted, then the user will have bought all three items and the OMS ensured that the budget of $100 was not exceeded.

In some embodiments, the criteria for retracting the remaining offers is different and some examples of criteria to retract the remaining offers are based on number of items to be purchased, total purchase price, desirability of each item, availability of the item and others.

In the preceding example, a single user had bid for two identical items, each item listed by a different advertiser, although it will be appreciated that there could me many more advertisers advertising the same item and the user is able to make an offer for each of the items to each of the advertisers.

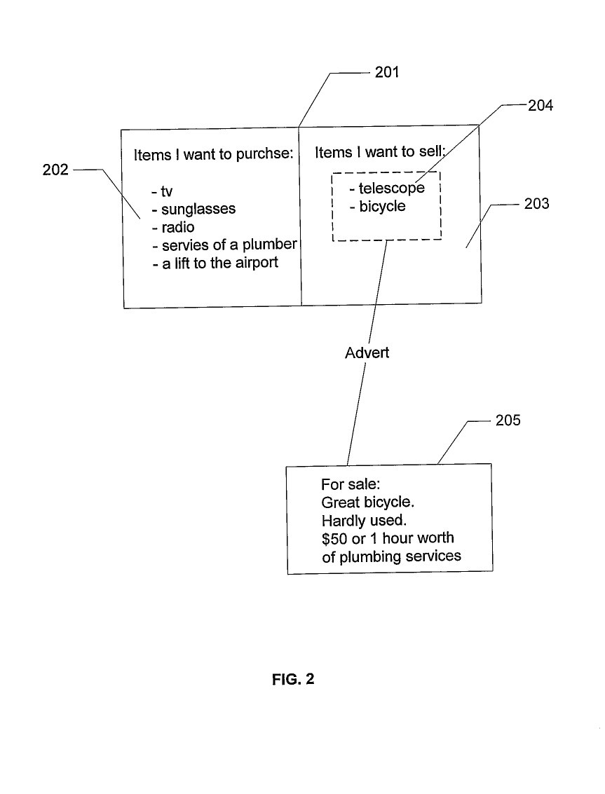

Referring now to FIG. 2, the OMS 107 allows the user 101 (and in this embodiment all other users 113) to create a list, called a wish-list 201, for listing predetermined items which the user wishes to purchase or sell. The list of items that the user wishes to purchase is shown as purchase list 202. The list of items that the user wishes to sell is shown as sell list 203. In this embodiment, the entire contents of the wish-list 201 are publicly available for viewing by other users. The user 101 has the option of allowing only portions of the wish-list 201 to be available to the public. For example, the user only wants, say, only their sell list 203 to be available for viewing by other users. In some embodiments, the user 101 determines that they only want one item on the sell list 203, say item 204 to be viewed by other users. In other embodiments the user allows the purchase list 202 to be viewed by other users so that they are able to make offers to the user to buy, sell or swap items on the list.

In this embodiment, the user 101 uses the items listed on the wish-list 201 to create an advertisement 205 that is listed on the OMS 107. The advertisement includes details of the item for sale, in this case a bicycle, and other details relevant to the sale. These details include the method of sale, such as auction, reverse auction or regular sale and also includes payment methods that the user 101 is willing to accept. Other details are included in other embodiments. In some embodiments, the user requests that payment be made in the form of money, services, other good or any combination of these forms of payment. In this example, the user has determined that the item is for sale at the price of $50 or 1 hour worth of plumbing services.

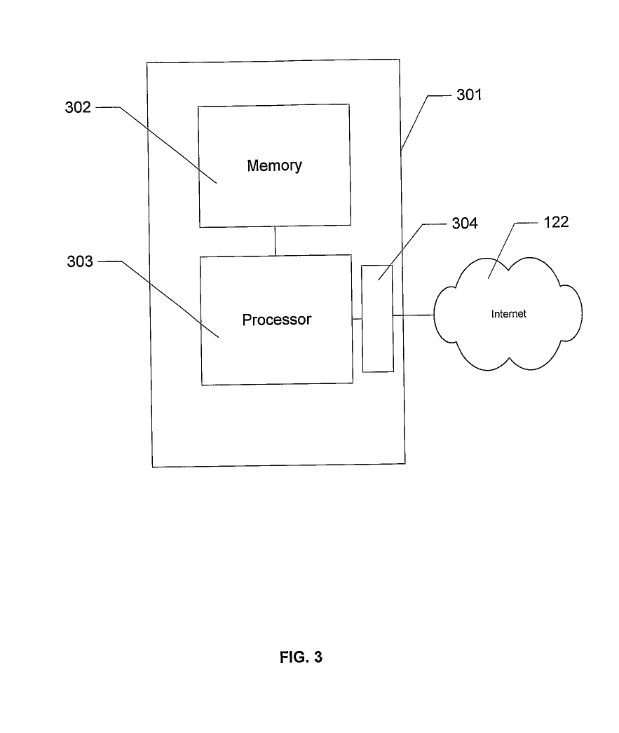

Referring now to FIG. 3 there is illustrated a computer device in the form of server 301 for implementing the OMS 107. The server 301 includes a memory device 302 and a processor 303 disposed in communication with the memory device 302. The processor is in communication with an interface 304 that is connected to the Internet 122. In this way, the processor 303 and therefore the server 301, is configured to receive offers and counter-offers such as those described in the examples above. As would be understood, processor 303 is further configured to transmit the details of the offers 108 and 109 to the respective sellers 103 and 104 for acceptance. It is further configured to receive from one of the sellers 103 the acceptance signal 112. It is further configured to retract the remaining offer 109 such that only one of the offers 108 and 109 is accepted. The further workings of the server will not be described in detail, but they would be understood by those skilled in the art.

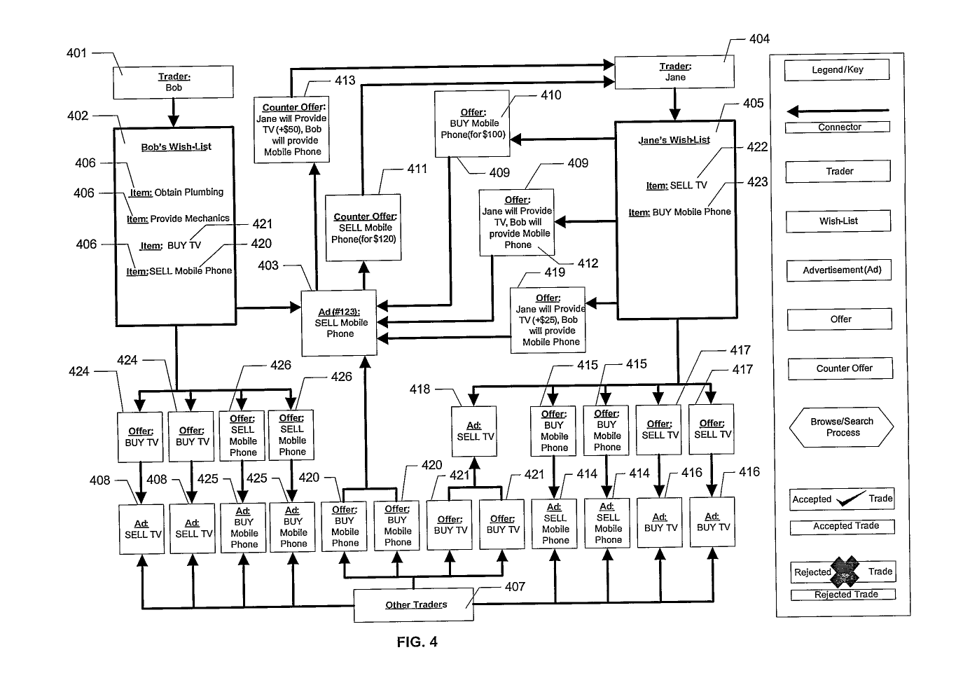

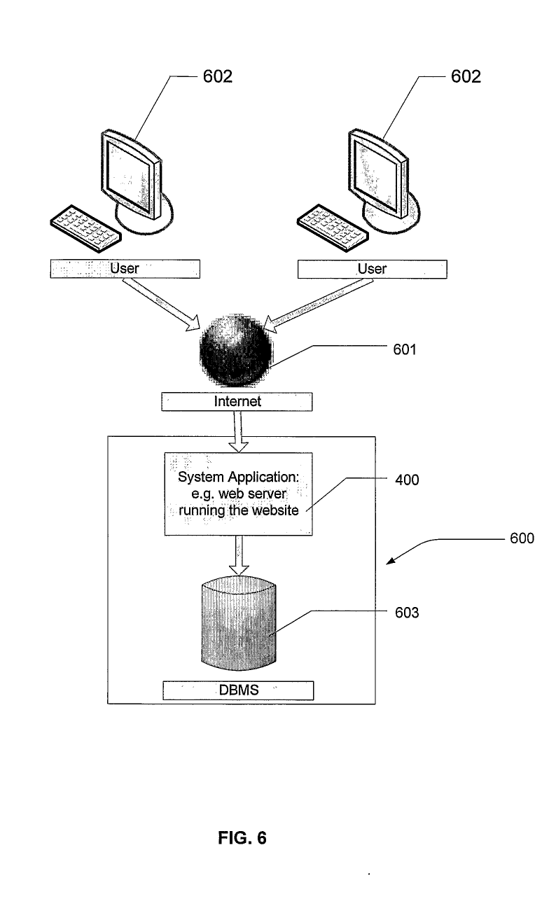

A more detailed description of the steps involved in an embodiment of the invention will now be described with reference to the flow charts of FIGS. 4 and 5 and FIG. 6. Within this example, the terms used are given the following meanings:

| Term | Meaning as used with reference to FIGS. 4, 5 and 6 |
|---|---|
| Trader | A Trader is a user of the system. For example, “John Smith”. |
| Item | An Item is something that a user or Trader would like to obtain or |
| | provide. For example, “I would like to obtain a mobile phone” or “I |
| | would like to provide the service of my car mechanic skills”. An item |
| | can be anything, for example, a physical product, a service, a person, |
| | an event etc. |
| | It would be understood that in some embodiments the word “obtain” |
| | is meant to incorporate the meanings of trade and buy. It will also be |
| | understood that in some embodiments, the word “provide” is meant to |
| | incorporate the meanings of sell and trade. |
| Wish-List | A Wish-List is a Trader's list of the Items that they wish to obtain or |
| | provide. For example, a Trader might have a Wish-List as follows: |
| | I want to sell my mobile phone. |
| | I want to buy a television. |
| | I want to provide my services as a car mechanic. |
| | I want to obtain the services of a plumber. |
| | Wish-List Items are not Advertised to the public unless the Trader |
| | creates an Advertisement. |
| Advertisement | An Advertisement is the public listing of one of the items from a |
| | Trader's Wish-List. For example, “I want to sell my new mobile |
| | phone to the best offer in the next 7 days”. |
| Advertising | The Advertising Trader refers to the Trader who has created the |
| Trader | advertisement in question. For example, if Bob created advertisement |
| | number 123 (to “sell his mobile phone”) and we are referring to |
| | advertisement 123, then Bob would be the “Advertising Trader”. |
| | There can be only one Advertising Trader for each Advertisement. |
| Offer | An Offer is a proposal made by a Trader in response to another |
| | Trader's Advertisement. For example, “I will buy your mobile phone |
| | for $100” or “I will provide my television to you if you provide me |
| | with your mobile phone” or “I will provide my television to you if |
| | you provide me with your mobile phone and $50”. |
| | An Offer can be contain money and/or Items and/or Services. |
| Offering | The Offering Trader refers to the Trader who has made an Offer to an |
| Trader | Advertisement. For example, if Jane makes an Offer to |
| | Advertisement number 123 (e.g. I will buy your mobile phone for |
| | $100), and we are talking about advertisement 123, then Jane would |
| | be referred to as an “Offering Trader”. |
| | There can be more than one Offering Trader for each Advertisement. |
| | For example, more than one Trader can make an Offer to an |
| | Advertisement. |
| Counter-Offer | A Counter-Offer is a proposal made by the Advertising Trader to an |
| | Offering Trader, in relation to the Offering Trader's original Offer. |
| | For example, Jane may make an Offer to Bob's Advertisement |
| | number 123 (e.g. “I will buy your mobile phone for $100”) and Bob |
| | is interested but would like something extra, so Bob could create a |
| | Counter-Offer to Jane (e.g. “Will you accept my mobile phone for |
| | $105?”). |
| Accepted | An Accepted Offer is an Offer (or Counter-Offer) that has been |
| Offer | accepted. For example, “I accept your offer to buy my mobile phone |
| | for $100”. |
| | Once an Offer has been accepted, then the agreement becomes a |
| | transaction. |
| Transaction | A Transaction is the agreement between two Traders to transact with |
| | one another. |

As in the embodiments described above, the OMS implemented in this embodiment allows multiple users to make multiple offers to multiple advertisers in response to advertisements for items. If the advertiser accepts any one of the offers then the OMS automatically retracts all the remaining offers. The user will therefore not unintentionally enter into a transaction with more than one seller. In this embodiment, Internet users 602 access the OMS 600 through the Internet 601.

The OMS 600 is implemented on a Linux Operating System. The Database Management System 603 is written in PostgreSQL and the coding language is PHP. It will be understood however that in different embodiments, the OMS is implemented with a number of hardware, software packages and coding languages and is not limited to those of this embodiment.

In this embodiment, the OMS is implemented on a single server, however in some embodiments the different applications are run on different servers. In some embodiments the “web service” and the “DBMS” (DataBase Management System) are implemented over multiple machines and in other embodiments, the applications are load balanced over multiple machines.

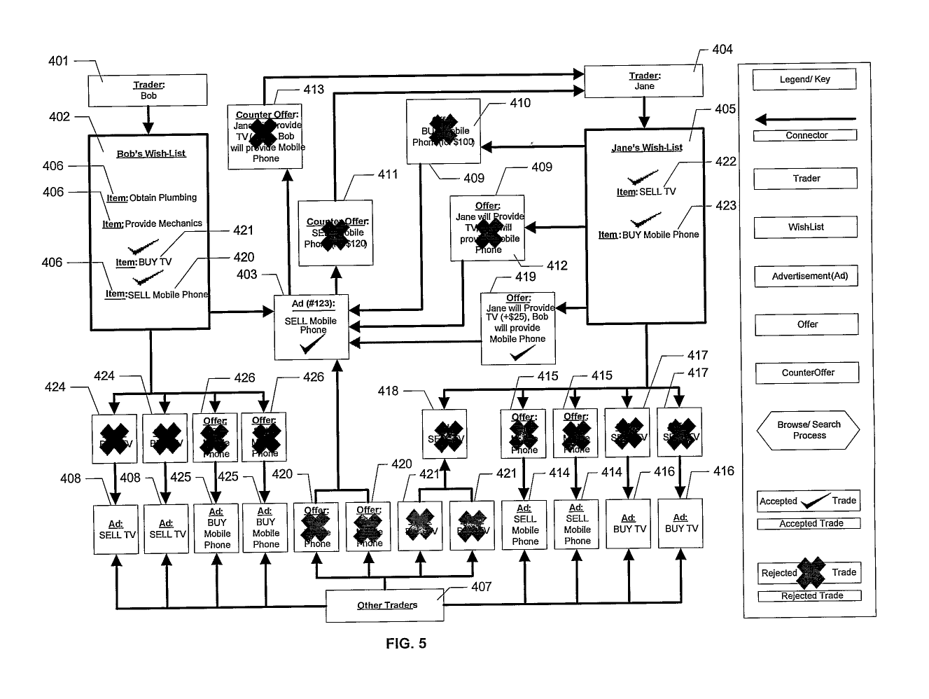

A more detailed description of the steps involved in a transaction of this embodiment is described below with the aid of FIG. 4 and FIG. 5.

Step 1. Trader Bob 401 accesses the OMS 600 and has a desire to buy, sell or trade various items. Bob accesses the wish-list functionality of the OMS and creates a list of items for his wish-list 402. Bob is able to specify the type of trade and the tradeable goods and/or services he wishes to buy, sell or trade. In this case, he creates the following items:

I want to sell my mobile phone.

I want to buy a television.

I want to provide my services as a car mechanic.

I want to obtain the services of a plumber.

Step 2. At the moment, the items listed on the wish-list 402 cannot be seen by any other users. Bob 401 decides that he would like to advertise to sell his mobile phone and would like to advertise this to other users. In this case Bob creates an advertisement designated by reference numeral 403. The advertisement is linked to the wish-list item of “I want to sell my mobile phone” and has the following conditions “I will accept the best offer at the end of 7 days and I will accept money and/or the trading of things”. The advertisement 403 is allocated “advertisement number 123” by the system 400.

Step 3. User Jane 404 accesses the OMS 600 and has a desire to buy and sell various items. She accesses the wish-list functionality of the OMS and creates a list of items for her wish-list 405. Jane is able to specify the type of trade and the tradeable goods and/or services she wishes to buy, sell or trade. In this case, she creates the following items:

I want to buy a mobile phone.

I want to sell a television.

Step 4. Jane accesses the OMS 600 and has a desire to buy a mobile phone. She accesses the search facility and browses the OMS advertisements to find the item that she is looking for.

Step 5. Jane finds Bob's advertisement 403 and makes an offer 410 to Bob. In this case the offer is “I will buy your mobile phone for $100”.

Step 6. Since Jane 404 is making an offer in response to Bob's advertisement 403, Jane is able to see Bob's wish-list 402. In this way Jane is able to see if there is anything that Bob desires that she can fulfil by trading or selling to him. A further feature in some embodiments allows Bob 401 to choose which of his wish-list items 406 can be seen, or not seen, by offering traders. In this case, Jane 404 sees that Bob 401 is looking for a television and she has a television that she would like to sell. Jane is able to make as many offers as she likes, so she makes another offer to Bob “I will provide you with my television if you provide me with your mobile phone”.

Step 7. In the meantime, Bob 401 has been using the search and browsing functionality of the OMS 600 to find other traders 407 who have advertised their desire to buy a mobile phone. Even though Bob has created a public advertisement for his mobile phone, he can still choose to offer it to as many other people as he likes and thus he increases his chances of finding a buyer for his phone.

Step 8. Bob 401 finds multiple advertisements 425 for buyers wanting to purchase mobile phones, so he makes multiple offers 426 to multiple traders.

Step 9. Bob 401 finds multiple advertisements 408 for people wanting to sell televisions, so he makes multiple offers 408 to multiple traders.

Step 10. Bob 401 reviews his advertisement 403 and sees that he has some offers 409 from Jane 404.

Step 11. Bob likes Jane's offer 410 of $100 and he could choose to accept this offer right now and complete the transaction. However, he would like to hold out for a better offer. Therefore Bob creates a counter-offer 411 to Jane 404. In this case the counter-offer is “I will provide you with my mobile phone for $120”. Note that at any time he can return to Jane's original offer 410 and choose to accept it even if she does not reply to his counter-offer 411.

Step 12. Bob 401 does not like Jane's offer of a television 412 and he could choose to reject this offer so that Jane knows he is not interested. Instead he makes a counter-offer 413. In this case the counter-offer is “I will provide you with my mobile phone if you provide me with your television set and $50”.

Step 13. In the meantime, Jane has been using the search and browsing functionality of the OMS 600 to find other traders 407 who are selling the mobile phone that she wishes to buy. Even though she has made an offer to Bob's advertisement 403, she can still make as many different offers as she likes, to as many different traders as she likes and thus she increases her chances of finding a match for this transaction.

Step 14. Jane 404 finds multiple advertisements 414 for people wanting to sell mobile phones, so she makes multiple offers 415 to multiple traders.

Step 15. Jane finds multiple advertisements 416 for people wishing to buy televisions, so she makes multiple offers 417 to multiple traders.

Step 16. Jane 404 decides that she might have more success in selling her television if she creates a public advertisement. This is because in this embodiment, traders are not able to search or browse wish-lists in the same way that they can search and browse advertisements. In other embodiments however, traders can search and browse wish-lists in the same way as they can search and browse advertisements. Therefore Jane creates an advertisement 418 “I will sell my television to the best offer in 10 days and I will only accept money (that is no trading).”Step 17. Jane reviews the counter-offers 411 and 413 made from Bob 401 and likes his counter-offer 413 of “I will provide you with my mobile phone if you provide me with your television set and $50”. Jane could accept the offer and complete the transaction. However, she thinks that she get a better offer so she makes an offer 419 to Bob “I will provide you with my television and $25 for your mobile phone”.

Step 18. In the meantime, Bob has received various other offers 420 from various other traders 407 for his mobile phone.

Step 19. Also, Jane 404 has been receiving various offers 421 from various traders for her television.

Step 20. Bob 401 reviews his advertisement 403 and out of all the offers, he most likes the offer 419 from Jane “I will provide you with my television and $25 for your mobile phone” so he chooses to accept the offer. Hence, Bob's winning advertisement and Jane's winning offer become complete.

Step 21. At this point, Bob 401 and Jane 404 have agreed on a transaction and the OMS 600 starts a process of automatically rejecting and retracting all other offers that are affected by this accepted transaction. It is important to note that all steps that occur as part of the “retraction and rejection of offers” (substep 21.1 to substep 21.8) process occur simultaneously and instantly as a result of step 20.

Substep 21.1 The OMS closes, that is marks as complete, the wish-list item 420 and the advertisement 403 that contains Bob's wish-list item of “I want to sell my mobile phone”, and Bob's wish-list item 421 of “I want to buy a Television”. In this way, no other transactions can occur.

Substep 21.2 The OMS 600 “closes”, that is marking as complete, the wish-list item 422 and advertisement 418 that contains Jane's wish-list item of “I want to sell my television”, and Jane's wish-list item 423 of “I want to buy a mobile phone. In this way no other transactions can occur.

Substep 21.3 It should be noted that if Bob had created an advertisement to buy a television, or if Jane had created an advertisement to buy a mobile phone, then the OMS 600 would close those advertisements so that no other transactions are able to occur.

Substep 21.4 The OMS rejects all offers 421 made to Jane's advertisement “I want to buy a television”, as she has already satisfied this need.

Substep 21.5 The OMS 600 rejects all offers 420 made to Bob's advertisement “I want to sell a mobile phone”, as he has already satisfied this need.

Substep 21.6 The OMS 600 retracts the all counter-offers 413 made by Bob on his advertisement “I want to sell a mobile phone”, as he has already satisfied this need.

Substep 21.7 The OMS 600 retracts all offers 424 made to other advertisements by Bob with his wish-list items “I want to buy a television” and “I want to sell a mobile phone”, as he has already satisfied this need.

Substep 21.8 The OMS 600 retracts all offers 417 made to other advertisements by Jane with her wish-list items “I want to sell a television” and “I want to buy a mobile phone”, as she has already satisfied this need.

Step 22 As can be seen in FIG. 5, at this point the OMS 600 has retracted and rejected all offers and advertisements including Bob's completed wish-list items and Jane's completed wish-list items. In this embodiment, the transaction process between Bob 401 and Jane 404, is left to be sorted out by the two traders separate of the OMS.

However, it will be appreciated that in some embodiments the OMS facilitates the payment transaction process and users may arrange for credit card payments, shipping, bank deposits as well as other types of payments.

Step 23 It should be noted that if Bob 401 had created an advertisement to buy a television, or if Jane 404 had created an advertisement to buy a mobile phone, then the OMS would reject all other offers that were made to these advertisements. In this way, no other transaction involving the television or the mobile phone can occur.

It should also be noted that in this embodiment, when a user makes an offer (or counter-offer) the trader or user can tell the OMS 600, if this transaction is successful, then this also satisfies my desire to obtain/provide item “x”, being any predetermined item selected by the user, and the OMS will automatically treat these items in the same way as described above (through the process of step 21).

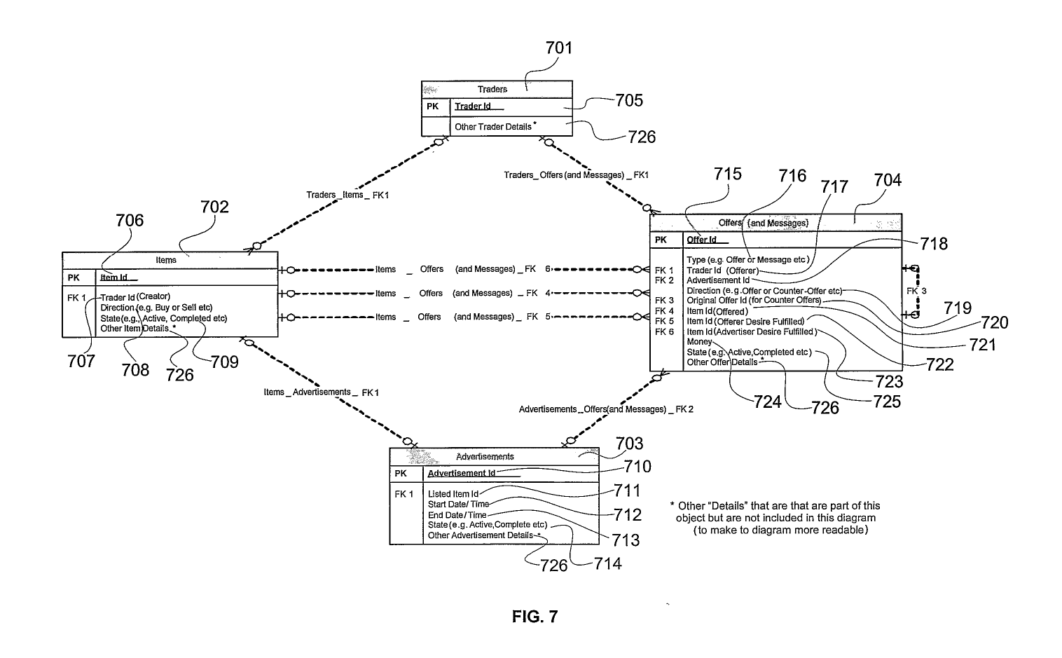

Referring now to FIG. 7, there is shown a database schema diagram describing a database as used in the example above. As would be understood, the database includes many different tables of data. Only the most significant of those will be described here, these being the tables of “Traders” 701 , “Items” 702, “Advertisements” 703 and “Offers” 704. The Traders table 701 stores information about each of the traders or users in the OMS. Within the Traders table 701 the most significant field is the “Trader Id” 705 that uniquely identifies each individual trader. The Trader Id is referenced by other tables to link Items and Advertisements and Offers to a specific Trader.

The Items table 702 stores information about each of the items in the OMS. The significant fields are the Item Id 706, Trader Id 707, Direction 708 and State 709. These fields are described in the table below:

| Field | Description |
|---|---|
| Item Id | Uniquely Identifies an Item (Links to Advertisements |
| | Table and Offers Table) |
| Trader Id | Links to Traders Table to Uniquely Identify a Trader |
| Direction | Specifies if the item is something that the trader would |
| | like to buy or sell |
| State | Specifies the status of the item (e.g. an “Active” |
| | item or “Completed” item etc) |

The Advertisements table 703 stores information about each of the advertisements that have been placed by users. The significant fields are Advertisement Id 710, Listed Item Id 711, Start Date/Time 712, End Date/Time 713 and State 714. These fields are described in the table below:

| Field | Description |
|---|---|
| Advertisement | Uniquely Identifies an Advertisement (Links to |
| Id | Items Table and Offers Table) |
| Listed Item Id | Links to Items Table to Uniquely Identify an Item |
| Start | Specifies the date/time that the advertisement listing |
| Date/Time | started |
| End | Specifies the date/time that the advertisement listing ends |
| Date/Time | |
| State | Specifies the status of the advertisements (e.g. an |
| | “Active” advertisement or “Completed” |
| | advertisement etc) |

The Offers table 704 stores information about each of the offers made by users. The significant fields are Offer Id 715, Type 716, Trader Id (Offerer) 717, Advertisement Id 718, Direction 719, Original Offer Id 720, Item Id (Offered) 721, Item Id (Offerer Desire Fulfilled) 722, Item Id (Advertiser Desire Fulfilled) 723, Money 724 and State 725. These fields are described in the table below:

| Field | Description |
|---|---|
| Offer Id | Uniquely Identifies an Offer (Links to Traders Table, Items |
| | Table and Advertisements Table) |
| Type | Specifies if this element is simply an “offer” or simply a “message” |
| Trader Id (Offerer) | Links to Traders Table to Uniquely Identify a Trader |
| Advertisement Id | Links to Advertisements Table to Uniquely Identify an |
| | Advertisement |
| Direction | Specifies if the Offer is an “Offer” (from an offering trader) or |
| | a counter-offer (from the advertising trader) |
| Original Offer Id | For Counter-Offers, Links to Offers Table to Uniquely Identify |
| | an Offer (that is the original offer that the counter-offer is being |
| | made on) |
| Item Id (Offered) | Links to Items Table to Uniquely Identify an Item (that is the |
| | item being offered) |
| Item Id (Offerer | Links to Items Table to Uniquely Identify an Item (that is the |
| Desire Fulfilled) | item that the offered wants to mark as “fulfilled” if the offer is |
| | successful) |
| Item Id (Advertiser | Links to Items Table to Uniquely Identify an Item (that is the |
| Desire Fulfilled) | item that the advertiser wants to mark as “fulfilled” if the |
| | counter-offer is successful) |
| Money | The amount of money that should be included in the offer |
| State | Specifies the status of the offer (e.g. an “Active” offer or |
| | “Completed” offer etc) |

It will be appreciated that all the tables include an Other Details field generally denoted as 726 that are part of their respective objects. These details are not included in the diagram in order to make the diagram more readable, however it will be understood that these fields can be used to store any number of further relevant and/or predetermined details.

In other embodiments of the invention, the OMS includes the feature of “Consideration Time” after the end of the advertisement listing time. For example, if a user's advertisement time finishes and the advertisement is no longer available to the public, then the user will have a period of time to consider all the offers and if desired, accept one. In other embodiments the consideration time is set by the life-time of the offer which is set by the user when the offer is made.

In some embodiments it is possible to convert wish-list items into advertisements. In some embodiments it is possible to swap or trade for an item that is in another user's unadvertised wish-list.

In some embodiments, the OMS is configured to handle multiple quantities—that is allowing users to swap a number of items and/or money for a number of other items. That is, allowing users to swap a “basket” of items for another “basket” of items). In some embodiments the OMS includes auto-matching technology that will notify users of advertisements (and in some embodiments offers) that have been made that meet their criteria. For example, a user is able to request notification of an advertisement being created that matches a certain criteria. In some embodiments, the criteria includes the category the advertisement is listed in, the location of the item and words that the advertisement contains. In other embodiments the auto-matching uses a combination of item and/or advertising attributes (with other item and user details) to provide intelligent auto-matching. In these instances a user could indicate, for example, a desire to obtain a car with the attributes of:

“condition”=“2nd hand”;

“colour”=“blue”;

“make”=“holden”;

“model”=“commodore”;

“year”>“1990”;

“year”<“2000”;

“price”<“AU$20,000”; and

“price”>“AU$2,000”.

As many attributes as are required by the user can be set. The system uses these attributes to automatically find and match other users' items and advertisements, which meet the set criteria. In some embodiments, the OMS includes the functionality to do a heuristic search for items in a user or users' wish-lists. In some embodiments the auto-matching feature allows users to find other users that have corresponding and matching wish list items. For example if a user wants to obtain “X” and provide “Y”, the system alerts the user of other users with corresponding or matching desires, in this case users that want to obtain “Y” and provide “X”. In this way the system further encourages and facilitates transactions between users.

In some embodiments users can deposit money into an account provided by the OMS and use it as credit to trade with users. For example, the systems would work as an intermediary or escrow service between the two trading parties and can secure the money and ensure both parties that the transaction is successfully completed. In some of these embodiments, users are able to withdraw money when required, or simply continue using the credit to trade with others.

In some embodiments, users are rewarded for achieving certain goals, for example referring another user to the OMS. Users earn credit to use within the site (e.g. to trade with others) or to use to pay advertisement fees that are charged by the OMS for advertising items.

In other embodiments, item attributes are represented as a tree of attributes that can be turned on and off by the user allowing other users to search and/or browse based on those attributes. For example, if the systems is implemented as a dating match service, a user can looking for a person with particular characteristics, such as having blue or brown eyes and blonde hair, who is 1.75 metres tall. The tree then provides the user with a tree with different categories that can be turned on or off:

| Eye Colour | Hair Colour | Height |
|---|---|---|
| Blue | Brown | Between 1.5 & 1.6 m |
| Brown | Blonde | Between 1.6 & 1.7 m |
| Green | Red | Between 1.7 & 1.8 m |

and so on for as many characteristics that are required to be implemented.

In some embodiments the OMS has a virtual shop facility whereby all the advertisements and/or items from a particular advertiser are displayed together. In this way other users are able to browse the advertisements and items offered by that particular advertiser.

In some embodiments users and advertisers have the ability to manually retract offers or counter-offers at any time. In other embodiments advertisers can reject offers at any time.

In some embodiments the advertiser is able to extend the advertisement time. In some instances the advertiser is able to re-list or re-advertise an advertisement and/or copy and clone an item or advertisement that is already stored in the OMS.

Other embodiments of the invention allow users to join online organisations or communities administered by the OMS. This allows users to search, browse, advertise, make offers and make agreements with people in the same community or organisation.

Some embodiments of the invention include a reputation management system that allows users to acquire trust levels through trade verification and validation methods. In one embodiment the users are allocated different levels of feedback, such as −2, −1, 0, 1 or 2. Feedback can be given multiple times but the system will only count the most recent feedback rating to determine the user's feedback score.

In some embodiments the system of the preferred embodiment includes the ability to reinstate offers that have been withdrawn. If, for example, two users enter into an agreement and one of the parties backs out from the agreement, the other party is able to reinstate any offers that were previously made to them. This is done either automatically by the system or in response to a request made by the user.

It will be appreciated that the illustrated embodiment provides a method and system for allowing a user to make a plurality of offers to a plurality of advertisers.

Although the invention has been described with reference to a specific example, it will be appreciated by those skilled in the art that the invention can be embodied in many other forms.

1. A method for allowing a user to make a plurality of offers to a plurality of advertisers, each offer being for an advertised item, the method including the steps of:
(a) receiving one or more offer signals that are indicative of the plurality of offers;
(b) being responsive to the offer signals for sending an advertiser signal to at least two of the advertisers, wherein the advertiser signal is indicative of the offers;
(c) being responsive to an acceptance from one of the at least two advertisers for retracting the remaining offer or offers.

2. A method according to claim 1 wherein the offer signals are received by an Offer Management System (OMS).

3. A method according to claim 3 wherein the OMS sends the advertiser signals and receives the acceptance signals.

4. A method according to claim 4 wherein the OMS retracts the remaining offer or offers.

5. A method according to claim 1 wherein each advertised item is related to an advertisement.

6. A method according to claim 5 wherein each advertised item is related to a respective advertisement.

7. A method according to claim 1 wherein the advertisement is for an item the advertiser wishes to sell and the offer is an offer to purchase the item from the advertiser.

8. A method according to claim 1 wherein the advertisement is for an item the advertiser wishes to buy and the offer is an offer to sell the item to the advertiser.

9. A method according to claim 1 including the step of:
(d) the OMS sending a confirmation signal to the user, wherein the confirmation signal is indicative of the acceptance signal.

10. A method according to claim 9 including the step of:
(e) receiving by the OMS a notification of payment between the user and the advertiser.

11. A method according to claim 10 wherein the payment from the user to the advertiser is by exchange of legal tender.

12. A method according to claim 10 wherein the payment is by exchange of goods and/or services.

13. A method according to claim 1 wherein the items include goods and/or services.

14. A method according to claim 1 wherein the OMS includes a list created by the user for listing predetermined items which the user wishes to purchase or sell.

15. A method according to claim 14 wherein the list is publicly available for viewing by other users.

16. A method according to claim 14 wherein the method includes the step of creating an advertisement for one or more of the items on the list.

17. A method according to claim 16 wherein the advertisement is in the form of an online auction conducted with the OMS.

18. A method according to claim 16 wherein the advertisement is in the form of an instant purchase conducted with the OMS.

19. A method according to claim 16 wherein the advertisement is in the form of a trade conducted with the OMS.

20. A method according to claim 14 wherein each predetermined item on the list is selectively available for viewing by other users.

21. A method for allowing a user to make a plurality of offers to a plurality of advertisers, each offer being for an advertised item, the method including the steps of:
(a) receiving one or more offer signals that are indicative of the plurality of offers;
(b) being responsive to the offer signals for sending an advertiser signal to at least two of the advertisers, wherein the advertiser signal is indicative of the offers;
(c) receiving one or more counter-offers from at least one of the advertisers.

22. A method according to claim 21 including the step of:
(d) sending a signal indicative of the at least one counter-offer to the user.

23. A method according to claim 22 including the step of:
(e) being responsive to an acceptance signal from the user for retracting the remaining counter-offer or counter-offers.

24. A method according to claim 23 wherein the offer signals are received by an Offer Management System (OMS).

25. A method according to claim 24 wherein the OMS sends the advertiser signals.

26. A method according to claim 25 wherein the OMS receives the one or more counter-offers.

27. A method according to claim 26 wherein the OMS sends the signal indicative of the at least one counter-offer to the user.

28. A method according to claim 27 wherein the OMS retracts the remaining counter-offer or counter-offers.

29. An offer management system adapted to accept a plurality of offers from a user for a plurality of items advertised by a plurality of advertisers and sending the offers to the related advertisers for acceptance, wherein if one of the offers is accepted then the offer management system retracts the remaining offers.

30. A computer device for allowing a user to make a plurality of offers to a plurality of advertisers, each offer being for an advertised item, the computer device including:
a memory device for storing information related to the offers;
a processor disposed in communication with the memory device, the processor configured to:
receive from the user the offers for each advertisers' item;
transmit data indicative of the offers to the related advertisers;
receive from one of the advertisers data indicative of the acceptance of the offer; and
retract the remaining offers such that only one of the offers is accepted.

31. A computer device according to claim 30 wherein said device is part of an Offer Management System (OMS).

32. A computer device according to claim 30 wherein each advertised item is related to an advertisement.

33. A computer device according to claim 32 where each advertised item is related to a respective advertisement.

34. A computer device according to claim 30 wherein the advertisement is for an item the advertiser wishes to sell and the offer is an offer to purchase the item from the advertiser.

35. A computer device according to claim 30 wherein the advertisement is for an item the advertiser wishes to buy and the offer is an offer to sell the item to the advertiser.

36. A computer device according to claim 30 wherein the processor is further configured to send a confirmation signal to the user, wherein the confirmation signal is indicative of the acceptance of the offer.

37. A computer device according to claim 36 wherein the processor is further configured to receive a notification signal from the user, wherein the notification signal is indicative of payment between the user and the advertiser.

38. A computer device according to claim 37 wherein the payment from the user to the advertiser is by exchange of legal tender.

39. A computer device according to claim 38 wherein the payment is by exchange of goods and/or services.

40. A computer device according to claim 39 wherein the items include goods and/or services.

41. A computer device according to claim 30 wherein the processor is further configured to receive from the user a list created by the user for listing predetermined items which the user wishes to purchase or sell.

42. A computer device according to claim 41 wherein the processor is further configured to store the list on the memory device.

43. A computer device according to claim 42 wherein the list is publicly available for viewing by other users.

44. A computer device according to claim 43 wherein the processor is further configured to create an advertisement for one or more of the items on the list.

45. A computer device according to claim 44 wherein the advertisement is in the form of an online auction conducted with the OMS.

46. A computer device according to claim 44 wherein the advertisement is in the form of an instant purchase conducted with the OMS.

47. A computer device according to claim 44 wherein the advertisement is in the form of a trade conducted with the OMS.

48. A computer device according to claim 44 wherein each predetermined item on the list is selectively available for viewing by other users.

49. An electronic trading system for allowing a user to make a plurality of offers to a plurality of advertisers, each offer being for an advertised item, the system including:
a memory device for storing information related to the offers;
a processor disposed in communication with the memory device, the processor configured to:
receive from the user the offers for each advertisers' item;
transmit data indicative of the offers to the related advertisers;
receive from one of the advertisers data indicative of the acceptance of the offer; and
retract the remaining offers such that only one of the offers is accepted.
